(19) United States
(12) Patent Application Publication
(10) Pub. No.: US 2006/0279865 A1
(43) Pub. Date: Dec. 14, 2006

(54) Optical element, retardation plate using same, optical laminated body,and display apparatus

(76) Inventors: Norihito Ito, Tokyo-to (JP); Takeshi Haritani, Tokyo-to (JP); Keiko Tazaki, Tokyo-to (JP); Shoji Takeshige, Tokyo-to (JP)

Correspondence Address: LADAS & PARRY LLP, 224 SOUTH MICHIGAN AVENUE, SUITE 1600, CHICAGO, IL, 60604, US

(21) Appl. No.: 11/348,212

(22) Filed: Feb. 6, 2006

(30) Foreign Application Priority Data
Feb. 8, 2005 (JP) 2005-031668

(51) Int. Cl. G02B 5/08

(52) U.S. Cl. 359/883

(57) ABSTRACT

An optical element, with an improved adhesion strength of the liquid crystal layer, and without substantial deterioration of the optical characteristics (such as transparency deterioration, white turbidity and display irregularity). The optical element has a transparent substrate, an alignment layer, and a liquid crystal layer formed on above-mentioned transparent substrate via the alignment layer. The liquid crystal layer contains an adhesion improving agent; a retardation plate including the above-mentioned optical element; an optical laminated body including the above-mentioned optical element and a polarizing plate; and a display apparatus including the above-mentioned retardation plate or optical laminated body disposed on the optical path.

### BACKGROUND OF THE INVENTION

1. Field of the Invention

The present invention relates to an optical element, and a retardation plate, an optical laminated body and a display apparatus comprising the optical element. More specifically, the present invention relates to an optical element having high adhesion strength of the respective layers comprising the optical element so as to improve the endurance, a retardation plate and a display apparatus comprising the optical element.

2. Description of the Related Art

Recently, a liquid crystal display and a display element using an organic electroluminescence or the like have been utilized in the extensive fields. For the display elements, as an optical functional layer for the display quality improvement, various kinds of optical elements such as a polarizing film, a retardation film, a light diffusing film and a brightness enhancement film are used.

In general, such an optical element often has a structure of a laminated body with an optical functional layer formed on a transparent substrate for various reasons.

For example, Japanese Patent Application Laid Open (JP-A) No. 2001-305301 proposes an optical film produced by forming a solvent resistant resin layer (water soluble resin layer) on a base material film having a poor solvent resistance and coating an ink containing a solvent thereon as an optical resin layer. This has a laminated body structure for protecting the base material film having the poor solvent resistance from the solvent of the optical functional layer resin layer. However, in general, the laminated body often involves a problem in the adhesion property between the respective layers.

Moreover, JP-A No. 10-10320 discloses a technique for improving the adhesion property by inserting an anchor coat layer between the layers having the low adhesion property. However, according to the technique, in the case of using a liquid crystalline material as the optical functional layer, a problem is involved in that obtaining a preferable alignment state by the liquid crystalline material on the anchor coat layer is extremely difficult, or the like.

As a common technique for improving the adhesion property between the layers, a method of using a silane base material is well known. For example, JP-A No. 2004-69975 reports a technique for improving the adhesion property between the glass and an adhesive layer by mixing a silane based material in the adhesive layer at the time of attaching a glass base material with an optical film via the adhesive layer. Moreover, JP-A No. 2003-121852 reports a technique of using a silane based compound as an anchor coat layer between the layers to improve the adhesion property.

### SUMMARY OF THE INVENTION

However, according to any of the techniques, sufficient adhesion strength of the liquid crystal layer has not been obtained while maintaining the preferable optical characteristics of the liquid crystal layer in an optical element having a liquid crystal layer. That is, in the case of providing an optical functional layer by coating a liquid crystal material, or the like and fixing the liquid crystal alignment state after the alignment process, it has been difficult to introduce a silane based compound for improving the adhesion property between the layers. Since the silane based material is not a liquid crystalline substance, the silane based material becomes the impurities at the time of aligning the liquid crystal substance so as to become the liquid crystal alignment inhibiting factor. As a result, the optical characteristics such as the transparency and others are lowered or the display irregularity is generated.

The present invention has been achieved in view of the above problems, and an object thereof is to provide an optical element and an optical laminated body, or the like with the improved adhesion strength of the liquid crystal layer while maintaining the preferable optical characteristics of the optical element by the use of a certain adhesion improving agent.

Accordingly, an optical element of the present invention comprises a transparent substrate, an alignment layer, and a liquid crystal layer formed on the transparent substrate via the alignment layer, wherein the liquid crystal layer contains an adhesion improving agent.

A preferable embodiment of the optical element according to the present invention includes one, wherein above-mentioned adhesion improving agent is a compound having an amino group.

Further, a preferable embodiment of the optical element according to the invention includes one, wherein above-mentioned adhesion improving agent is a compound having a silane group.

Furthermore, a preferable embodiment of the optical element according to the invention includes one, wherein the liquid crystal layer contains an ultraviolet ray cured product of a monomer showing the nematic liquid crystal property and having an ultraviolet ray curing property-functional group, and the adhesion improving agent.

Moreover, a preferable embodiment of the optical element according to the invention includes one, wherein the content of the adhesion improving agent is 0.005% by weight or more and 5% by weight or less with respect to the solid content amount of the coating solution for forming the liquid crystal layer.

Still furthermore, a preferable embodiment of the optical element according to the invention includes one, wherein the monomer showing the nematic liquid crystal property is fixed in a state of a parallel, perpendicular or helical structure with respect to the transparent substrate.

In addition, a retardation plate of the present invention comprises the optical element.

Moreover, an optical laminated body according to the present invention comprises above-mentioned optical element, a retardation plate and a polarizing plate.

Moreover, a display apparatus according to the present invention comprises above-mentioned retardation plate or above-mentioned optical laminated body disposed on the optical path.

According to the present invention, an optical element and an optical laminated body, or the like with the adhesion strength of the liquid crystal layer improved can be obtained while maintaining the preferable optical characteristics of the optical element.

Although the optical element according to the present invention has the adhesion improving agent in the liquid crystal, since the adhesion improving agent of the present invention does not become an alignment inhibiting factor of the liquid crystalline monomer in the liquid crystal layer, the adhesion strength of the liquid crystal layer can be improved substantially without the phenomena such as the transparency deterioration, the white turbidity, and the display irregularity.

In particular, according to an optical element with the liquid crystalline monomer in the liquid crystal layer aligned by providing a liquid crystal layer on an alignment layer and the alignment state fixed, compared with the case of including an adhesive agent in the alignment layer, the optical functional properties (such as the liquid crystal alignment property and the transparency) cannot be deteriorated.

### BRIEF DESCRIPTION OF THE DRAWINGS

FIG. 1 is a cross sectional view schematically showing a preferable one example of an optical element according to the present invention.

FIGS. 2A to 2D are cross sectional views schematically showing preferable specific examples of an optical element according to the present invention.

FIGS. 3A to 3F are a diagram schematically showing a particularly preferable production method of an optical element according to the present invention.

### DESCRIPTION OF THE PREFERRED EMBODIMENT

(1) Optical Element

An optical element of the present invention comprises a transparent substrate, an alignment layer, and a liquid crystal layer formed on the transparent substrate via the alignment layer, wherein the liquid crystal layer contains an adhesion improving agent.

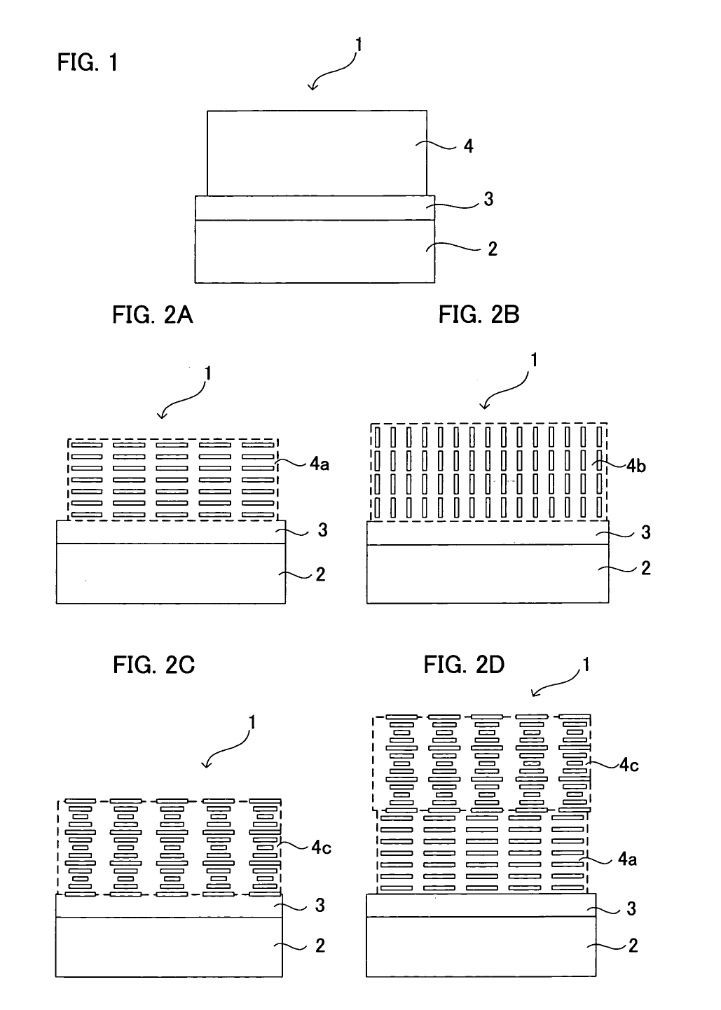

As a particularly preferable specific example of the optical element of the present invention, one shown in FIG. 1 can be presented.

The optical element 1 shown in FIG. 1 comprises a transparent substrate 2, an alignment layer 3, and a liquid crystal layer 4 formed on above-mentioned transparent substrate 2 via the alignment layer 3. An adhesion improving agent is contained in the liquid crystal layer 4.

In the liquid crystal layer 4 of FIG. 1, a monomer showing the nematic liquid crystal property can be fixed in a state aligned in a direction parallel to the transparent substrate 2 as shown as the liquid crystal layer 4a of FIG. 2A. Moreover, a monomer showing the nematic liquid crystal property can be fixed in a state aligned in the direction perpendicular to the transparent substrate 2 as shown as the liquid crystal layer 4a of FIG. 2B. In the case where a monomer showing the nematic liquid crystal property is aligned in the direction parallel to the transparent substrate 2 as shown in FIG. 2A (that is, in the case of the homogeneous structure (parallel alignment structure)), it provides an optical functional layer referred to as a A plate. In the case where a monomer showing the nematic liquid crystal property is aligned in the direction perpendicular to the transparent substrate 2 as shown in FIG. 2B (that is, in the case of the homeotropic structure (vertical alignment structure)), it provides a positive (+) C plate.

Moreover, in the liquid crystal layer 4 of FIG. 1, a monomer showing the nematic liquid crystal property may be a liquid crystal layer aligned helically, having the cholesteric regularity by being mixed with a chiral agent as shown as the liquid crystal layer 4c of FIG. 2C. In this case, it is referred to as a negative (−) C plate.

Moreover, the liquid crystal layer 4 of the optical element 1 according to the present invention may be one with a plurality of liquid crystal layers having the same or different alignment states laminated. FIG. 2D shows an optical element 1 according to the present invention with the liquid crystal layer 4 formed as a laminated body which comprises a liquid crystal layer 4a aligned in the direction parallel to the transparent substrate 2 and a liquid crystal layer 4c of a helical structure. In this case, as needed, an appropriate transparent layer may be provided between the liquid crystal layer 4a and the liquid crystal layer 4c. AS a representative example of such an appropriate transparent layer, for example, an alignment layer to be described later can be presented.

A liquid crystal layer 4b with a liquid crystalline monomer as shown in FIG. 2B aligned in the direction perpendicular to the transparent substrate 2, or a liquid crystal layer 4c with a liquid crystalline monomer as shown in FIG. 2C aligned helically can be used instead of the liquid crystal layer 4a shown in FIG. 2D. Moreover, a liquid crystal layer 4a with a liquid crystalline monomer as shown in FIG. 2A aligned in the direction parallel to the transparent substrate 2, or a liquid crystal layer 4b with a liquid crystal line monomer as shown in FIG. 2B aligned in the direction perpendicular to the transparent substrate 2 can be used instead of the liquid crystal layer 4c shown in FIG. 2D.

Moreover, according to the optical element 1 of the present invention, as needed, one kind or two or more kinds of other layers (not shown) may be interposed between the transparent substrate 2 and the alignment layer 3, between the alignment layer 3 and the liquid crystal layer 4, or between the respective liquid crystal layers in the case where the liquid crystal layer 4 is a laminated body of a plurality of liquid crystal layers. As such an interposed layer, a protection layer, a polarizing layer, a retardation layer and an alignment layer can be presented.

<Transparent Substrate>

The transparent substrate 2 in the optical element 1 according to the present invention has a function of a supporting substrate for another constituent member of an optical element, such as an alignment layer, a liquid crystal layer and others. Therefore, in this embodiment, a conventionally known transparent material such as a glass and a transparent resin can be utilized as the transparent substrate 2 of the optical element 1.

As a preferable material for the transparent substrate of the present invention, for example, a polyester resin such as a polyethylene terephthalate; a cellulose based resin such as a triacetate cellulose (TAC); a diacetyl cellulose, and an acetate butylate cellulose; an olefin based resin such as a cyclic olefin based polymer and a polymethyl pentene; a resin made from a polyether sulfone, a polyacrylic based resin, a polyurethane based resin, a polycarbonate, a polysulfone, a polyether, a polyether ketone and a poly(meth)acrylonitrile; a glass such as a quartz glass, a borosilicate glass and a soda lime glass; or the like can be presented. Among these examples, a TAC without a birefringence is particularly preferable since a polarizing plate with a diffusing layer can be produced by laminating a light diffusing film and a polarizing element, and furthermore, a liquid crystal display apparatus with the excellent display quality can be obtained using the polarizing plate.

The transparent substrate may be a continuous lengthy film having a certain length, and industrially, it may be a continuous film supplied in a rolled up form. The length of the lengthy film may be as long as 10,000 m in some cases.

The thickness of the transparent substrate differs depending on the specific application of the optical element, the size, or the like. The thickness is, in general and preferably, about 25 μm to 1,000 μm so that it is in a range of so-called a film, a sheet or a plate.

<Liquid Crystal Layer>

The liquid crystal layer 4 in the optical element 1 of the present invention contains at least one kind of the adhesion improving agent.

<<Adhesion Improving Agent>>

A preferable adhesion improving agent used in the present invention is a compound represented by the below-mentioned formula (1):

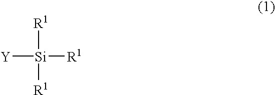

, wherein Y denotes an amino group, an epoxy group, a mercapto group, a chloropropyl group, an isocyanate group, a vinyl group, a styryl group, a methacryloxy group, or an acryloxy group; and R1 each independently denotes OCH₃ or OC₂H₅.

From the viewpoint of the alignment property of the liquid crystal and the adhesion strength, Y is preferably an amino group, an epoxy group, a mercapto group, a chloropropyl group and an isocyanate group; and it is particularly preferably an amino group. R1 is particularly preferably a methoxy group.

The content of above-mentioned adhesion improving agent with respect to the solid content amount of the coating solution for forming above-mentioned liquid crystal layer is 0.005% by weight or more and 5% by weight or less; and it is preferably 0.005% by weight or more and 2% by weight orless. In the case where it is less than 0.005% by weight, the adhesion strength improving effect between the transparent substrate 2 and(/or) the alignment layer 3 cannot be realized sufficiently. On the other hand, in the case where it is over 5% by weight, although the adhesion improving effect is sufficient, a preferably alignment characteristic can hardly be obtained so that the optical functional property can be deteriorated due to generation of the haze rise, the irregularity, or the like.

<<Liquid Crystalline Monomer>>

As a preferable liquid crystalline monomer for forming a liquid crystal layer of the present invention, a monomer showing the nematic liquid crystal property having at least one ultraviolet ray polymerizable functional group at the end can be presented. In the present invention, a liquid crystalline monomer having two or more ultraviolet ray polymerizable functional groups in a molecule is particularly preferable.

As such a liquid crystalline monomer, the compounds disclosed in for example JP-A Nos. 7-258638, 10-508882, and 2003-287623 can be used.

As the compounds particularly preferable in the present invention, the following compounds can be presented. 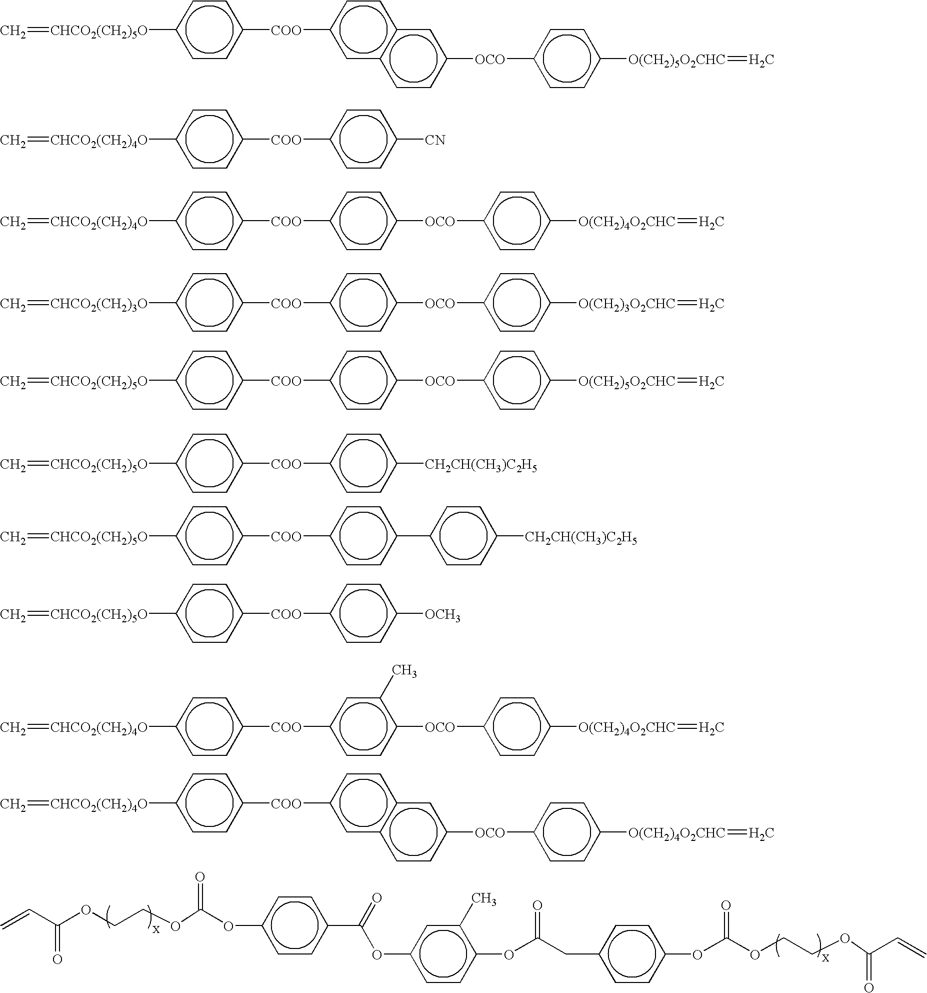
<<Chiral Material>>

In the case of forming a liquid crystal layer 4c with a liquid crystalline monomer aligned helically as shown in FIG. 2C, it is preferable to use a chiral material in addition to above-mentioned liquid crystalline monomer. As such a chiral material, anyone having the chiral property with respect to a nematic liquid crystal substance and one or more polymerizable groups on the end can be used optionally in accordance to the purpose. For example, the compounds disclosed in JP-A Nos. 7-258638, 10-508882, and 2003-287623 can be used.

As the chiral materials particularly preferable in the present invention, the following compounds can be presented. 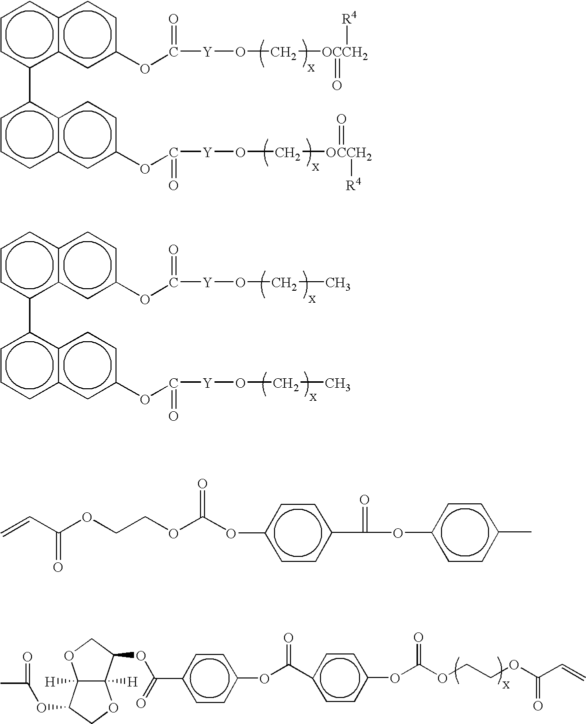
<<Formation of the Liquid Crystal Layer>>

The liquid crystal layer 4 in the optical element 1 of the present invention can be formed by preparing a coating solution made of an organic solvent containing at least above-mentioned adhesion improving agent and liquid crystalline monomer for forming the liquid crystal layer, and applying a process for curing above-mentioned liquid crystalline monomer by exposing an active energy ray to the layer formed by coating the coating solution.

As a preferable organic solvent used for preparing the coating solution, a cyclohexanone, or the like can be presented.

To the coating solution, as needed, above-mentioned chiral agent, a polymerization initiator, a plasticizer, a surfactant, or the like can be included.

As the polymerization initiator to be used, a benzyl (it is also referred to as a bibenzoyl), a benzoin isobutyl ether, a benzoin isopropyl ether, a benzophenone, a benzoyl benzoic acid, a methyl benzoyl benzoate, a 4-benzoyl-4′-methyl diphenyl sulfide, a benzyl methyl ketal, a dimethyl amino methyl benzoate, a 2-n-butoxy ethyl-4-dimethyl amino benzoate, a p-dimethyl amino isoamylbenzoate, a 3,3′-dimethyl-4-methoxybenzophenone, a methylobenzoyl formate, a 2-methyl-1-(4-(methyl thio)phenyl)-2-morpholino propane-1-on, a 2-benzyl-2-dimethyl amino-1-(4-morpholino phenyl)-butane-1-on, a 1-(4-dodecyl phenyl)-2-hydroxy-2-methyl propane-1-on, a 1-hydroxy cyclohexyl phenyl ketone, a 2-hydroxy-2-methyl-1-phenyl propane-1-on, a 1-(4-isopropyl phenyl)-2-hydroxy-2-methyl propane-1-on, a 2-chloro thioxantone, a 2,4-diethyl thioxantone, a 2,4-diisopropyl thioxantone, a 2,4-dimethyl thioxantone, an isopropyl thioxantone, a 1-chloro-4-propoxy thioxantone, or the like can be presented. The amount of the polymerization initiator is 0.1 to 5 parts by weight with respect to 100 parts by weight of the liquid crystalline monomer, and it is preferably 0.5 to 3 parts by weight.

As to the method for coating above-mentioned coating solution, it can be carried out by a known method (such as spin coating, bar coating, extrusion coating, direct gravure coating, reverse gravure coating and die coating).

A drying process is carried out in general before exposing the active energy ray to the coating film with the main purpose of eliminating or reducing the organic solvent in the coating solution.

By applying a curing process for above-mentioned liquid crystalline monomer by exposing an active energy ray, preferably an ultraviolet ray to the coating film, the liquid crystal layer 4 of the optical element 1 of the present invention can be formed.

<Alignment Layer>

The alignment layer 3 in the optical element 1 of the present invention has the function alignment ability of aligning above-mentioned liquid crystalline monomer in above-mentioned liquid crystal layer 4 provided in contact with the alignment layer 3 in the parallel direction (in the case of FIG. 2A), or in the perpendicular direction (in the case of FIG. 2B), or helically (in the case of FIG. 2C) with respect to the transparent substrate 2. As the alignment layer 3, any one having the transparency and capable of providing a sufficient alignment property to above-mentioned liquid crystalline monomer can be used optionally. In the case where the alignment layer 3 has a sufficient hardness, it can also provide the function as a protection layer (hard coating layer).

Such an alignment layer 3 can be formed from for example a resin composition made of a polyimide, a polyamide, a polyvinyl alcohol, or the like; or it can be formed from an active energy ray curing type resin composition. In particular, it can also be formed from an active energy ray curing type resin composition to form a high hardness layer by the three dimensional cross-linking generated by the active energy ray.

Here, as the active energy ray, an ultraviolet ray and an electron beam are representative examples, and an ultraviolet ray is preferable in terms of the process. As the ultraviolet ray, a light beam including a wavelength in a range of 100 to 450 nm is preferable; and a light beam including a wavelength in a range of 250 to 400 nm is more preferable. A light beam in this range can easily be obtained by a common light source, and furthermore, by mixing a commonly commercially available photo polymerization initiator, chemical reaction by the active energy ray can be obtained easily and efficiently.

As a preferable specific example of the resin composition to be cured by an ultraviolet ray, those having an acrylate based functional group, such as a polyester resin having a relatively low molecular weight, a polyether resin, an acrylic resin, an epoxy resin, an urethane resin, an alkyd resin, a spiroacetal resin, a polybutadiene resin, and a polythiol polyene resin can be presented.

As an ultraviolet ray curing type monomer for forming such an ultraviolet ray curing type resin, for example a monofunctional monomer and a multifunctional monomer of a reactive ethyl(meth)acrylate, an ethyl hexyl(meth)acrylate, a styrene, a methyl styrene, and a N-vinyl pyrrolidone such as a polymethylol propane tri(meth)acrylate, a hexane diol(meth)acrylate, a triethylene(polypropylene)glycol(meth)diacrylate, a tripropylene glycol di(meth)acrylate, a diethylene glycol di(meth)acrylate, a 1,6-hexane diol di(meth)acrylate, a neopentyl glycol di(meth)acrylate, an isocyanuric acid EO modified diacrylate, apentaerythritol tri(meth)acrylate, a dipentaerythritol hexa(meth)acrylate, and a bisphenol fluorene derivative such as a bisphenoxy ethanol fluorene diacrylate, and a bisphenol fluorene diepoxy acrylate can be used alone or as a mixture.

In the present invention, in particular, it is preferable to include a triethylene (polypropylene) glycol diacrylate, a 1,6-hexane diol di(meth)acrylate, an isocyanuric acid EO modified diacrylate, or a bisphenol fluorene derivative.

Then, in such an ultraviolet ray curing type resin, as the photo polymerization initiator, acetophenones, benzophenones, a Michler's benzoyl benzoate, an α-amiroxym ester, a tetramethyl thiuram monosulfide or thioxantones; and as the photo sensitizing agent, a n-butyl amine, a triethyl amine, a poly-n-butyl phosophine, or the like can be used as a mixture.

As a specific preferable example of the alignment layer comprising above-mentioned ultraviolet ray curing type resin, for example, in the case of FIG. 2A or 2B, an alignment layer produced by generating the dimerization reaction in the constituent molecules by exposing an active energy ray having a specific polarization direction and thereby aligning the liquid crystalline monomer parallel to or perpendicular to the polarization direction can be cited.

Moreover, an alignment plate with a liquid crystalline monomer aligned in the direction parallel to the transparent substrate 2 as particularly shown in FIG. 2A includes an alignment plate with the rubbing process applied. As the rubbing process, in general a method of rubbing the film surface by rotating a rubbing cloth selected from the materials such as a rayon, a cotton, a polyamide and a polymethyl methacrylate wound around a metal roll in a state contacting with a film, or conveying the substrate film with the roll fixed, can be used.

On the other hand, in the case of FIG. 2C, a photo alignment layer with above-mentioned liquid crystalline monomer aligned helically in the presence of above-mentioned chiral material can be presented.

Here, as the material capable of obtaining the alignment ability with respect to the liquid crystal layer by the dimerization, a polyvinyl cinnamate (PVCi) is well known. It has the double bond portions of two side chains parallel to the polarizing light beam opened by exposing a polarizing ultraviolet ray so as to be re-bonded with each other. Additionally, a material having a cinnamoyl group, a coumarine, or a chalcon group can be used as well. For example, in the present invention, the materials disclosed in JP-A Nos. 7-138380 and 10-324690 can be used.

<Production of the Optical Element>

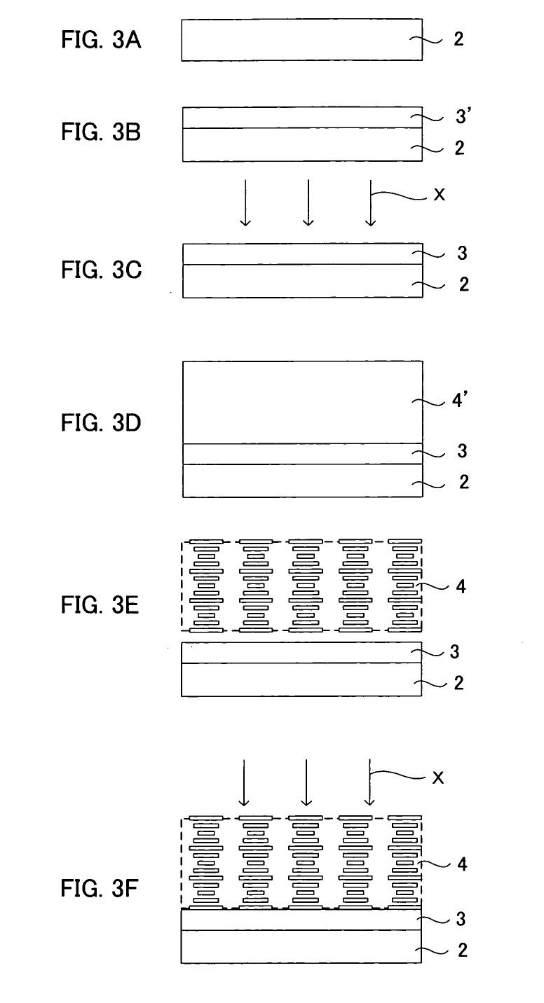

Next, a particularly preferable production method of an optical element 1 in the present invention will be explained with reference to FIGS. 3A to 3F.

First, an active energy ray curing type, preferably ultraviolet ray curing type alignment layer 3 forming resin composition layer 3′ is formed (FIG. 3B) on one side surface of a transparent substrate 2 made of a glass or a transparent resin (FIG. 3A).

Next, by exposing an active energy ray X, preferably an ultraviolet ray to the resin composition layer, the curingprocess is carried out for above-mentioned alignment layer 3 so as to form an alignment layer 3 (FIG. 3C). Here, an alignment process such as a rubbing process or a photo alignment process by exposing an active energy ray having an optional polarization state, or the like can be properly carried out for the alignment layer 3.

Next, a coating solution 4′ containing a liquid crystalline monomer and an adhesion improving agent, and as needed, other components such as a chiral material, a polymerization initiator, a plasticizer and a surfactant is coated on the alignment layer 3 by the method disclosed in above-mentioned <<Formation of the liquid crystal layer>>, and thereafter a drying process is applied (FIG. 3D).

The liquid crystalline monomer in the coating solution is aligned by the function of above-mentioned alignment layer 3 in the direction parallel to or perpendicular to the transparent substrate 2, or helically by the function of above-mentioned chiral material, or the like (FIG. 3E).

Thereafter, by applying a curing process comprising the step of exposing an active energy ray X, preferably an ultraviolet ray, a liquid crystal layer 4 with the alignment state substantially fixed can be formed (FIG. 3F).

Since the liquid crystal layer 4 is formed with a coating solution containing the adhesion improving agent as mentioned above, the adhesion strength between the alignment layer 3 and the transparent substrate 2 is strengthened.

<Retardation Plate, Optical Laminated Body and Display Apparatus>

The retardation plate according to the present invention comprises above-mentioned optical element; the optical laminated body according to the present invention comprises above-mentioned optical element and a polarizing plate; and the display apparatus according to the present invention comprises above-mentioned retardation plate, or above-mentioned optical laminated body disposed on the optical path.

As the retardation plate and the polarizing plate according to the present invention, those conventionally used in the optical elements can be utilized.

Then, in the display apparatus of the present invention, as the constituent materials or the constituent members other than the optical element of the present invention, those conventionally used in the display apparatus can be utilized. For example, a display apparatus using an organic electroluminescence as a light-emitting member is a preferable specific example of the display apparatus of the present invention.

### EXAMPLES

Hereinafter, the present invention will be explained further specifically with reference to the examples.

### Example 1

Formation of the Hard Coating Layer

A coating solution of 40% by weight solid content concentration was prepared by dissolving 40 g of Kayarad PET-30 (produced by NIPPON KAYAKU CO., LTD.) and 2 g of IRGACURE 907 (produced by Ciba Specialty Chemicals) in 60 g of a methyl ethyl ketone.

The coating solution was coated onto a triacetyl cellulose film TD-80 (produced by Fuji Photo Film Co., Ltd.) by the bar coating method so as to have the film thickness after drying of 4 μm, and a heat drying operation was carried out for 3 minutes at 90° C. Then, under the nitrogen atmosphere, an ultraviolet ray curing process comprising the step of exposing a light beam of a high pressure mercury lamp by 100 mj/cm² was carried out so as to form a hard coating layer.

Formation of the Alignment Layer

An alignment layer solution of a 1% by weight solid content concentration was prepared by dissolving 99 g of a cyclohexanone in 1.0 g of a photo alignment film material containing a polymer having a cinnamoyl group. The solution was coated onto above-mentioned hard coating layer by the bar coating method so as to have the film thickness after drying of 0.1 μm, and a heat drying operation was carried out for 2 minutes at 80° C. Then, under the air atmosphere, by exposing a polarizing UV by 10 mj/cm² to the coated film, an alignment layer was formed.

Formation of the Liquid Crystal Layer

A liquid crystal layer forming coating solution of a 20% by weight solid content concentration was prepared by dissolving:

17.2 g of the following nematic liquid crystalline monomer

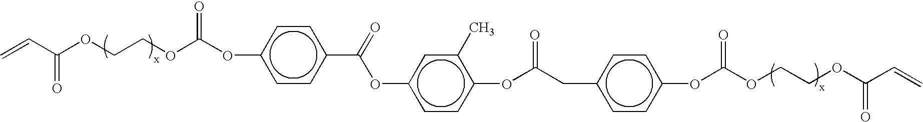

2.8 g of the following chiral material

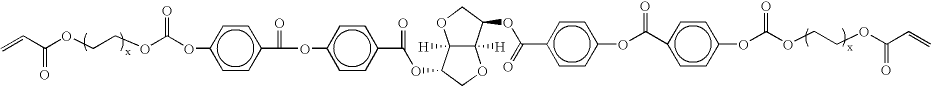

0.01 g of an aminopropyl trimethoxy silane having an amino group at the end as the silane compound (KBM903 produced by Shin-Etsu Chemical Co., Ltd.) and 1 g of IRGACURE 907 (produced by Ciba Specialty Chemicals) in 80 g of a cyclohexanone.

Then, the coating solution was coated onto above-mentioned alignment layer by the bar coating method so as to have the film thickness after drying of 2 μm, and a heat drying operation was carried out for 2 minutes at 80° C. Then, under the nitrogen atmosphere, by exposing a light beam of a high-pressure mercury lamp by 100 mj/cm² to carry out an ultraviolet ray curing, a liquid crystal layer was produced on above-mentioned alignment layer.

### Example 2

Formation of the Hard Coating Layer

A coating solution of 40% by weight solid content concentration was prepared by dissolving 40 g of Kayarad PET-30 (produced by NIPPON KAYAKU CO., LTD.) and 2 g of IRGACURE 907 (produced by Ciba Specialty Chemicals) in 60 g of a methyl ethyl ketone.

The coating solution was coated onto a triacetyl cellulose film TD-80 (produced by Fuji Photo Film Co., Ltd.) by the bar coating method so as to have the film thickness after drying of 4 μm, and a heat drying operation was carried out for 3 minutes at 90° C. Then, under the nitrogen atmosphere, an ultraviolet ray curing process comprising the step of exposing a light beam of a high pressure mercury lamp by 100 mj/cm² was carried out so as to form a hard coating layer.

Formation of the Alignment Layer

An alignment layer solution of a 1% by weight solid content concentration was prepared by dissolving 99 g of a cyclohexanone in 1.0 g of a photo alignment film material containing a polymer having a cinnamoyl group. The solution was coated onto above-mentioned hard coating layer by the bar coating method so as to have the film thickness after drying of 0.1 μm, and a heat drying operation was carried out for 2 minutes at 80° C. Then, under the air atmosphere, by exposing a polarizing UV by 10 mj/cm² to the coated film, an alignment layer was formed.

Formation of the Liquid Crystal Layer

A liquid crystal layer forming coating solution of a 20% by weight solid content concentration was prepared by dissolving:

20 g of the following nematic liquid crystalline monomer

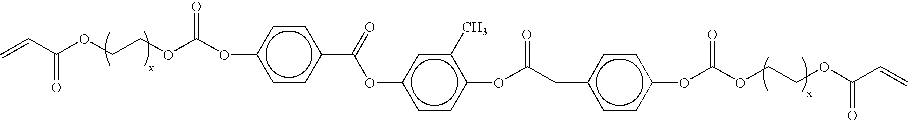

0.01 g of an aminoethyl aminopropyl trimethoxy silane having an amino group at the end as the silane compound (KBM603 produced by Shin-Etsu Chemical Co., Ltd.) and 1 g of IRGACURE 907 (produced by Ciba Specialty Chemicals) in 80 g of a cyclohexanone.

Then, the coating solution was coated onto above-mentioned alignment layer by the bar coating method so as to have the film thickness after drying of 2 μm, and a heat drying operation was carried out for 8 minutes at 90° C. Then, under the nitrogen atmosphere, by exposing a light beam of a high-pressure mercury lamp by 100 mj/cm² to carry out an ultraviolet ray curing, a liquid crystal layer was produced on above-mentioned alignment layer.

### Comparative Example 1

It was carried out in the same manner as in the example 1 except that the silane compound was not added in the liquid crystal layer forming coating solution of the example 1.

### Example 3

It was carried out in the same manner as in the example 1 except that 0.05 g of a 3-glycydoxy propyl triethoxy silane (KBE 403 produced by Shin-Etsu Chemical Co., Ltd.) having an epoxy group at the end was added as the silane compound in the liquid crystal layer forming coating solution of the example 1.

### Example 4

It was carried out in the same manner as in the example 1 except that 0.05 g of a 3-mercapto propyl triethoxy silane (KBM 803 produced by Shin-Etsu Chemical Co., Ltd.) having a mercapto group at the end was added as the silane compound in the liquid crystal layer forming coating solution of the example 1.

### Example 9

It was carried out in the same manner as in the example 1 except that 0.05 g of a 3-chloropropyl triethoxy silane (KBM 703 produced by Shin-Etsu Chemical Co., Ltd.) having a chloropropyl group at the end was added as the silane compound in the liquid crystal layer forming coating solution of the example 1.

### Example 10

It was carried out in the same manner as in the example 1 except that 0.05 g of a 3-isocyanate propyl trimethoxy silane (KBE 9007 produced by Shin-Etsu Chemical Co., Ltd.) having an isocyanate group at the end was added as the silane compound in the liquid crystal layer forming coating solution of the example 1.

### Comparative Example 2

Formation of the Hard Coating Layer

A coating solution of 40% by weight solid content concentration was prepared by dissolving 40 g of Kayarad PET-30 (produced by NIPPON KAYAKU CO., LTD.) and 2 g of IRGACURE 907 (produced by Ciba Specialty Chemicals) in 60 g of a methyl ethyl ketone, and dissolving 0.05 g of a 3-glycydoxy propyl triethoxy silane (KBM 403 produced by Shin-Etsu Chemical Co., Ltd.) having an epoxy group at the end as the silane compound.

The coating solution was coated onto a triacetyl cellulose film TD-80 (produced by Fuji Photo Film Co., Ltd.) by the bar coating method so as to have the film thickness after drying of 4 μm, and a heat drying operation was carried out for 3 minutes at 90° C. Then, under the nitrogen atmosphere, an ultraviolet ray curing process comprising the step of exposing a light beam of a high pressure mercury lamp by 100 mj/cm² was carried out so as to form a hard coating layer.

Formation of the Alignment Layer

An alignment layer solution of a 1% by weight solid content concentration was prepared by dissolving 99 g of a cyclohexanone in 1.0 g of a photo alignment film material containing a polymer having a cinnamoyl group. The solution was coated onto above-mentioned hard coating layer by the bar coating method so as to have the film thickness after drying of 0.1 μm, and a heat drying operation was carried out for 2 minutes at 80° C. Then, under the air atmosphere, by exposing a polarizing UV by 10 mj/cm² to the coated film, an alignment layer was formed.

Formation of the Liquid Crystal Layer

A liquid crystal layer forming coating solution was prepared in the same manner as in the example 1 except that the silane compound was not added.

Then, the coating solution was coated onto above-mentioned alignment layer by the bar coating method so as to have the film thickness after drying of 2 μm, and a heat drying operation was carried out for 8 minutes at 90° C. Then, under the nitrogen atmosphere, by exposing a light beam of a high-pressure mercury lamp by 100 mj/cm² to carry out an ultraviolet ray curing, a liquid crystal layer was produced on above-mentioned alignment layer.

<Evaluation>

For the samples of the examples 1 to 4, 9, 10, and the comparative example 1 to 2, a lattice pattern tape-peeling test was carried out based on the JIS K5400 as the adhesion property test. Using a cellophane tape (“CT24”, produced by NICHIBAN CO., LTD.), after sticking the same to the film with the ball of a finger, it was peeled off. The judgment was made based on the number of the grids not peeled off out of 100 grids such that the case with the functional layer not at all peeled off was 100/100; the case completely peeled off was 0/100; and furthermore, the case of adhesion (with the adhesion improved as compared with the case completely peeled off) but with the insufficient adhesion property, that was, 1/100 to 99/100 was Δ. Moreover, the case of 0/100 was judged to be X for the adhesion insufficiency, and the case of 100/100 was judged to be ◯ for the adhesion sufficiency.

Moreover, as the alignment state evaluation of the optical functional layer, the haze (cloudiness value) of the film was measured by a haze meter. In the case the haze value was 0.3% or more, it was judged to be X, and in the case it was 0.3% or less, it was judged to be ◯. The results are shown in the table 1.

Those satisfied both the lattice pattern tape peeling test and the haze value were only those having an amino group as the functional group. Moreover, in the case a silane compound was added to the lower layer, even though the adhesion property was sufficient, white turbidity (haze value rise) was generated in the upper layer.

TABLE 1

| | Adhesion | | Lattice | | | |
|---|---|---|---|---|---|---|
| | improving | | pattern | | | |
| | agent | Included | peeling test | | Haze (%) | |
| | (Y group) | layer | (judgment) | | (judgment) | |
| Example 1 | Amino group | Liquid | 100/100 | ◯ | 0.17 | ◯ |
| | | crystal | | | | |
| | | layer | | | | |
| Example 2 | Amino group | Liquid | 100/100 | ◯ | 0.18 | ◯ |
| | | crystal | | | | |
| | | layer | | | | |
| Comparative | Not added | None | 0/100 | X | 0.16 | ◯ |
| example 1 | | | | | | |
| Example 3 | Epoxy group | Liquid | 10/100 | Δ | 0.44 | X |
| | | crystal | | | | |
| | | layer | | | | |
| Example 4 | Mercapto | Liquid | 15/100 | Δ | 0.40 | X |
| | group | crystal | | | | |
| | | layer | | | | |
| Example 9 | Chloropropyl | Liquid | 8/100 | Δ | 0.41 | X |
| | group | crystal | | | | |
| | | layer | | | | |
| Example 10 | Isocyanate | Liquid | 12/100 | Δ | 0.45 | X |
| | group | crystal | | | | |
| | | layer | | | | |
| Comparative | Epoxy group | Alignment | 100/100 | ◯ | 0.49 | X |
| example 2 | | layer | | | | |

### Example 5

It was carried out in the same manner as in the example 1 except that 0.001 g of an aminopropyl trimethoxy silane having an amino group at the end was added as the silane compound (KBM903 produced by Shin-Etsu Chemical Co., Ltd.) in the liquid crystal layer forming coating solution of the example 1.

### Example 6

It was carried out in the same manner as in the example 1 except that 0.1 g of an aminopropyl trimethoxy silane having an amino group at the end was added as the silane compound (KBM903 produced by Shin-Etsu Chemical Co., Ltd.) in the liquid crystal layer forming coating solution of the example 1.

### Example 7

It was carried out in the same manner as in the example 1 except that 0.0002 g of an aminopropyl trimethoxy silane having an amino group at the end was added as the silane compound (KBM903 produced by Shin-Etsu Chemical Co., Ltd.) in the liquid crystal layer forming coating solution of the example 1.

### Example 8

It was carried out in the same manner as in the example 1 except that 1 g of an aminopropyl trimethoxy silane having an amino group at the end was added as the silane compound (KBM903 produced by Shin-Etsu Chemical Co., Ltd.) in the liquid crystal layer forming coating solution of the example 1.

<Evaluation>

For the samples of the examples 1 and 5 to 8, a lattice pattern tape-peeling test was carried out based on the JIS K5400 as the adhesion property test. Using a cellophane tape (”CT24”, produced by NICHIBAN CO., LTD.), after sticking the same to the film with the ball of a finger, it was peeled off. The judgment was made based on the number of the grids not peeled off out of 100 grids such that the case with the functional layer not at all peeled off was 100/100, and the case completely peeled off was 0/100. Further, the case of 0/100 was judged to be X for the adhesion insufficiency, and the case of 100/100 was judged to be ◯ for the adhesion sufficiency. Moreover, in the case of 1/100 to 99/100, the adhesion property improving effect can be provided and it was judged to be Δ.

Moreover, as the alignment state evaluation of the optical functional layer, the haze (cloudiness value) of the film was measured by a haze meter. In the case the haze value was 0.5% or more, it was judged to be X, and in the case it was 0.3% or less, it was judged to be ◯. Moreover, in the case the haze value was over 0.3 and under 0.5, it was judged to be Δ. The results are shown in the table 2.

Those having preferable results in both the lattice pattern tape peeling test and the haze value were those with the silane compound addition amount of 0.005% or more and 0.5% or less.

TABLE 2

| | | |
|---|---|---|
| Addition amount | | |
| of the adhesion- | | |
| improving | Lattice | |
| agent with | pattern | |
| respect to the | peeling test | Haze (%) |
| solid content | (judgment) | (judgment) |

| | | | | | |
|---|---|---|---|---|---|
| Example 7 | 0.001% | 14/100 | Δ | 0.18 | ◯ |
| Example 5 | 0.005% | 100/100 | ◯ | 0.19 | ◯ |
| Example 1 | 0.05% | 100/100 | ◯ | 0.17 | ◯ |
| Example 6 | 0.5% | 100/100 | ◯ | 0.28 | ◯ |
| Example 8 | 5.0% | 100/100 | ◯ | 0.80 | X |

1. An optical element comprising a transparent substrate, an alignment layer, and a liquid crystal layer formed on the transparent substrate via the alignment layer, wherein the liquid crystal layer contains an adhesion improving agent.

2. The optical element according to claim 1, wherein the adhesion improving agent is a compound having an amino group.

3. The optical element according to claim 1, wherein the adhesion improving agent is a silane compound.

4. The optical element according to claim 1, wherein the liquid crystal layer contains an ultraviolet ray cured product of a monomer showing a nematic liquid crystal property and having a functional group of an ultraviolet ray curing property, and the adhesion improving agent.

5. The optical element according to claim 1, wherein a content of the adhesion improving agent is 0.005% by weight or more and 5% by weight or ess with respect to a solid content amount of a coating solution for forming the liquid crystal layer.

6. The optical element according to claim 4, wherein the monomer showing the nematic liquid crystal property is fixed in a state of a parallel structure, a perpendicular structure or a helical structure with respect to the transparent substrate.

7. A retardation plate comprising the optical element according to claim 1.

8. An optical laminated body comprising the optical element according to claim 1 and a polarizing plate.

9. A display apparatus comprising the retardation plate according to claim 7 disposed on an optical path.
